(19) United States
(12) Patent Application Publication
(10) Pub. No.: US 2010/0211320 A1
(43) Pub. Date: Aug. 19, 2010

(54) RECONSTRUCTING A SEISMIC WAVEFIELD

(76) Inventors: Massimiliano Vassallo, Brighton (GB); Ali Ozbek, Cambridge (GB); Dirk-Jan Van Manen, Surrey (GB); Ahmet Kemal Ozdemir, Asker (NO)

Correspondence Address: WesternGeco L.L.C.;Kevin McEnaney, IP Dept, 10001 Richmond Avenue, HOUSTON, TX, 77042-4299, US

(21) Appl. No.: 12/370,710

(22) Filed: Feb. 13, 2009

(51) Int. Cl. G01V 1/28

(52) U.S. Cl. 702/14

(57) ABSTRACT

A technique to reconstruct a seismic wavefield includes receiving datasets, where each dataset is indicative of samples of one of a plurality of measurements of a seismic wavefield that are associated with a seismic survey. The technique includes modeling the plurality of measurements of a seismic wavefield as being generated by the application of at least one linear filter to the seismic wavefield. The technique includes processing the datasets based on the linear filter(s) and a generalized matching pursuit technique to generate data indicative of a spatially continuous representation of the seismic wavefield.

### BACKGROUND

The invention generally relates to reconstructing a seismic wavefield.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, a technique to reconstruct a seismic wavefield includes receiving datasets, where each dataset is indicative of samples of one of a plurality of measurements of a seismic wavefield associated with a seismic survey. The technique includes modeling the plurality of measurements of a seismic wavefield as being generated by the application of at least one linear filter to the seismic wavefield. The technique includes processing the datasets based on the linear filter(s) and a generalized matching pursuit technique to generate data indicative of a spatially continuous representation of the seismic wavefield.

In another embodiment of the invention, an apparatus includes an interface and a processor. The interface receives datasets, where each dataset is indicative of samples of one of a plurality of measurements of a seismic wavefield that are associated with a seismic survey. The processor is adapted to process the datasets based on at least one linear filter and a generalized matching pursuit technique to generate data indicative of a spatially continuous representation of the seismic wavefield. Each of the plurality of measurements of a seismic wavefield is modeled as being derived by the application of one of the filter(s) to the seismic wave field.

In yet another embodiment of the invention, an article includes a computer readable storage medium containing instructions that when processed by a computer cause the computer to receive datasets. Each dataset is indicative of samples of one of a plurality of measurements of a seismic wavefield that are associated with a seismic survey. The instructions when executed by the computer cause the computer to process the datasets based on at least one linear filter and a generalized matching pursuit technique to generate data indicative of a spatially continuous representation of the seismic wavefield. Each of the plurality of measurements of a seismic wavefield is modeled as being generated by the application of one of the linear filters to the seismic wavefield.

Advantages and other features of the invention will become apparent from the following drawing, description and claims.

### BRIEF DESCRIPTION OF THE DRAWING

FIG. 1 is a schematic diagram of a marine seismic acquisition system according to an embodiment of the invention.

FIG. 2 is an illustration of a generalized sampling expansion theorem-based scheme according to an embodiment of the invention.

FIGS. 3 and 4 are flow diagrams depicting generalized matching pursuit-based techniques to reconstruct a seismic wavefield according to embodiments of the invention.

FIG. 5 is a schematic diagram of a processing system according to an embodiment of the invention.

### DETAILED DESCRIPTION

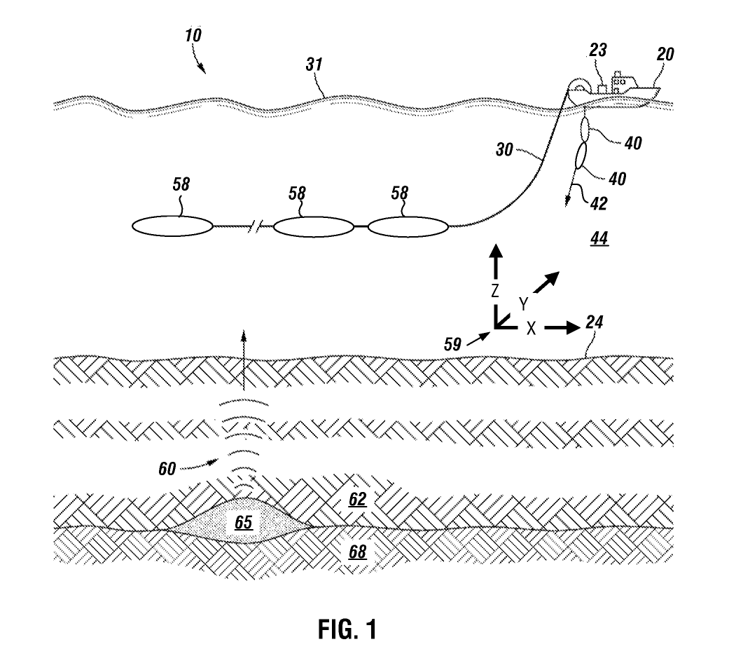

FIG. 1 depicts an embodiment 10 of a marine-based seismic data acquisition system in accordance with some embodiments of the invention. In the system 10, a survey vessel 20 tows one or more seismic streamers 30 (one exemplary streamer 30 being depicted in FIG. 1) behind the vessel 20. It is noted that the streamers 30 may be arranged in a spread in which multiple streamers 30 are towed in approximately the same plane at the same depth. As another non-limiting example, the streamers may be towed at multiple depths, such as in an over/under spread, for example.

The seismic streamers 30 may be several thousand meters long and may contain various support cables (not shown), as well as wiring and/or circuitry (not shown) that may be used to support communication along the streamers 30. In general, each streamer 30 includes a primary cable into which is mounted seismic sensors that record seismic signals. The streamers 30 contain seismic sensors 58, which may be, depending on the particular embodiment of the invention, hydrophones (as one non-limiting example) to acquire pressure data or multi-component sensors. For embodiments of the invention in which the sensors 58 are multi-component sensors (as another non-limiting example), each sensor is capable of detecting a pressure wavefield and at least one component of a particle motion that is associated with acoustic signals that are proximate to the sensor. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the multi-component seismic sensor may include one or more hydrophones, geophones, particle displacement sensors, particle velocity sensors, accelerometers, pressure gradient sensors, or combinations thereof.

For example, in accordance with some embodiments of the invention, a particular multi-component seismic sensor may include a hydrophone for measuring pressure and three orthogonally-aligned accelerometers to measure three corresponding orthogonal components of particle velocity and/or acceleration near the sensor. It is noted that the multi-component seismic sensor may be implemented as a single device (as depicted in FIG. 1) or may be implemented as a plurality of devices, depending on the particular embodiment of the invention. A particular multi-component seismic sensor may also include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, a particular point, seismic data indicative of the pressure data with respect to the inline direction.

The marine seismic data acquisition system 10 includes seismic sources 40 (two exemplary seismic sources 40 being depicted in FIG. 1), such as air guns and the like. In some embodiments of the invention, the seismic sources 40 may be coupled to, or towed by, the survey vessel 20. Alternatively, in other embodiments of the invention, the seismic sources 40 may operate independently of the survey vessel 20, in that the sources 40 may be coupled to other vessels or buoys, as just a few examples.

As the seismic streamers 30 are towed behind the survey vessel 20, acoustic signals 42 (an exemplary acoustic signal 42 being depicted in FIG. 1), often referred to as “shots,” are produced by the seismic sources 40 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are created by the sources 40 produce corresponding reflected acoustic signals, or pressure waves 60, which are sensed by the seismic sensors 58. It is noted that the pressure waves that are received and sensed by the seismic sensors 58 include “up going” pressure waves that propagate to the sensors 58 without reflection, as well as “down going” pressure waves that are produced by reflections of the pressure waves 60 from an air-water boundary, or free surface 31.

The seismic sensors 58 generate signals (digital signals, for example), called “traces,” which indicate the acquired measurements of the pressure wavefield and particle motion. The traces are recorded and may be at least partially processed by a signal processing unit 23 that is deployed on the survey vessel 20, in accordance with some embodiments of the invention. For example, a particular seismic sensor 58 may provide a trace, which corresponds to a measure of a pressure wavefield by its hydrophone; and the sensor 58 may provide (depending on the particular embodiment of the invention) one or more traces that correspond to one or more components of particle motion.

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23. In accordance with other embodiments of the invention, the representation may be processed by a seismic data processing system that may be, for example, located on land or on the vessel 20. Thus, many variations are possible and are within the scope of the appended claims.

A towed marine seismic survey may have a spread of streamers 30 that are spaced apart in the crossline (y) direction, which means that the seismic sensors are rather sparsely spaced apart in the crossline direction, as compared to the inline (x) spacing of the seismic sensors. As such, the pressure wavefield may be relatively densely sampled in the inline (x) direction while being sparsely sampled in the crossline direction to such a degree that the sampled pressure wavefield may be aliased in the crossline direction. In other words, the pressure data acquired by the seismic sensors may not, in general, contain sufficient information to produce an unaliased construction (i.e., an unaliased continuous interpolation) of the pressure wavefield in the crossline direction.

In accordance with embodiments of the invention described herein, a generalized sampling expansion (GSE) theorem-based scheme is used to model the relationship between the measurements acquired in a seismic survey to a seismic wavefield; and based on this relationship, a generalized matching pursuit technique is used for purpose of constructing an unaliased and continuous representation of the seismic wave field.

The GSE theorem is generally described in Papoulis, A., 1977, Generalized Sampling Expansion, IEEE Trans. Cir. Syst., Vol. 24, No. 11, pp. 652-654. According to the GSE theorem, a band-limited signal s(x) may be uniquely determined in terms of the samples (sampled at 1/n of the Nyquist wavenumber) of the responses of n linear systems that have s(x) as the input.

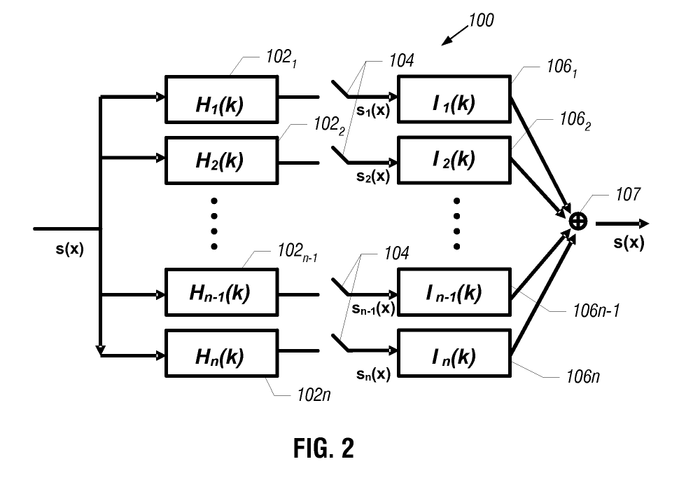

FIG. 2 is an illustration 100 of the GSE theorem-based scheme. A signal s(x) is filtered by a bank of n linear and independent forward filters 102₁, 102₂ . . . 102ₙ₋₁ and 102ₙ. The n filtered signals are sampled (as depicted by the switches 104) with a sampling rate that can be as low as 1/n the Nyquist rate of s(x). Such decimation generates n sequences (i.e., sequences s₁(x) to sₙ(x)) that are subject to aliasing up to order n.

The GSE theorem states that from the n filtered, decimated and aliased signals, it is possible to reconstruct the unaliased signal s(x). In other words, it is possible to determine n reconstruction filters 106₁, 106₂, 106ₙ₋₁ and 106ₙ that when applied to the sequences produce signals that when added together (as illustrated by the adder 107) produce an unaliased reconstruction of the s(x) signal.

In seismic processing, the GSE theorem may be applied for purposes of modeling multicomponent acquisitions as being the decimated output of a filter bank, where the measured wavefield is the input. Such a model allows multichannel interpolation and reconstruction of the desired wavefield.

For example, the pressure wavefield and the horizontal (crossline) component of the particle velocity wavefield may be interpolated pursuant to a GSE theorem-based scheme as follows. Wave propagation theory provides the following:

$$\frac{\partial P ( x , y , z , t )}{\partial y} = ρ \frac{\partial {V}_{y} ( x , y , z , t )}{\partial t} , \qquad Eq . 1$$

where “P” represents the pressure wavefield; “V_{y}” represents the crossline component of the particle velocity vector; “x” represents the inline coordinate of the seismic sensor; “y” represents the crossline coordinate of the seismic sensor; “z” represents the depth of the seismic sensor; and “t” represents time.

Eq. 1 can be re-written in the frequency wavenumber domain as follows:

$${V}_{y} ( ω , {k}_{x} , {k}_{y} , z ) = \frac{{k}_{y}}{ρ ω} P ( ω , {k}_{x} , {k}_{y} , z ) = {H}_{2} ( ω , {k}_{x} , {k}_{y} , z ) P , \qquad Eq . 2$$

where “H₂” represents one of the GSE theorem filters 102 (see FIG. 2). By omitting the dependence from (ω, kₓ, z) to simplify the notation and considering H₁(k_{y})≡1, the multichannel acquisition may be described as follows:

P=H₁(k_{y})P, and Eq. 3

V_{y}=H₂(k_{y})P Eq. 4

The system described in Eqs. 3 and 4 may therefore be modeled as a GSE-compliant system, with n=2. The system may be used to measure pressure and the horizontal component of particle velocity to interpolate the pressure in a spatial bandwidth up to twice the theoretical Nyquist bandwidth of the original measurements.

The GSE theorem-based scheme of FIG. 2 may also describe the joint interpolation and deghosting problem. As described in U.S. patent application Ser. No. 12/131,870, entitled, “JOINTLY INTERPOLATING AND DEGHOSTING SEISMIC DATA,” which was filed on Jun. 2, 2008 and is hereby incorporated by reference in its entirety, the s(x) signal is the upgoing pressure wave, which is to be reconstructed. The linear filters Hₘ(k_{y}) are the ghost operators for the pressure wavefield and for the particle velocities, as set forth below:

$$\begin{matrix}P = ( 1 + G ) {P}^{up} = {H}_{1} ( {k}_{y} ) {P}^{up} , & Eq . 5 \\ {V}_{y} = \frac{{k}_{y}}{ρ ω} ( 1 + G ) {P}^{up} = {H}_{2} ( {k}_{y} ) {P}^{up} , \\ and & Eq . 6 \\ {V}_{z} = \frac{{k}_{z}}{ρ ω} ( 1 - G ) {P}^{up} = {H}_{3} ( {k}_{y} ) {P}^{up} . & Eq . 7\end{matrix}$$

In Eqs. 5-7, “G” represents the ghost operator (in amplitude and phase); “k_{z}” and “k_{y}” represent the vertical wavenumber and the horizontal (cross-line) wavenumber, respectively; and “H₁,” “H₂” and “H₃” represent the linear filters 102 (see FIG. 2).

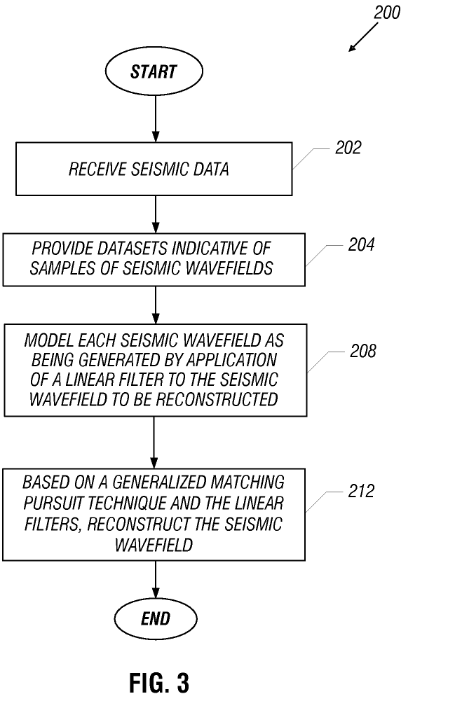

Applying the above-described principles, a technique 200 that is depicted in FIG. 3 may be used in accordance with embodiments of the invention to reconstruct an unaliased and continuous seismic wavefield. Pursuant to the technique 200, seismic data are received (block 202). As further described below, the seismic data may represent samples of the seismic wavefield to be reconstructed; or, alternatively, the seismic data may be used to estimate samples for the seismic wavefield to be estimated. Regardless of whether the samples are directly or indirectly derived from the seismic data, datasets are provided (block 204), which are indicative of samples of measurements of a seismic wavefield. Each of these seismic measurements is modeled (block 208) as being generated by application of a linear filter to the seismic wavefield that is to be reconstructed. The linear filters are different and independent of each other and may, in general, be the linear filters described in the GSE theorem-based scheme 100 of FIG. 2. Pursuant to the technique 200, based on the application of a generalized matching pursuit technique and the linear filters, an unaliased and continuous representation of the wavefield is reconstructed, pursuant to block 212.

U.K. Patent Application No. 0714404.4, entitled, “METHOD OF REPRESENTING SIGNALS,” (Attorney Docket No. 57.0730) (called the “MIMAP application” herein), which was filed on Jun. 13, 2007, and is hereby incorporated by reference in its entirety, discloses a matching pursuit technique to reconstruct a pressure wavefield from the system that is defined by Eqs. 3 and 4. This technique aims to describe the signal to be reconstructed as a linear combination of a set of optimal basis functions; and those basis functions are filtered respectively by H₁(k_{y})=1 and H₂(k_{y})=k_{y}/ρω in order to optimally match the input signals at the sampled positions. This technique applies the forward operator to the basis functions; iteratively chooses the basis functions that, filtered, jointly best match the available input (filtered) signals; and uses the selected basis functions to reconstruct the output, unfiltered, at the desired positions. This operation does not require the inverse problem to be solved for purposes of determining the reconstruction filters 106 (see FIG. 2).

In a Generalized Matching Pursuit technique performing joint interpolation and deghosting (called the “GMP-JID” application herein and described in U.S. patent application Ser. No. 12/131,870), the forward linear filters Hₖ(k_{y}) described in Eqs. 5, 6, 7, are applied to the basis functions to match the measured full wavefield. The basis functions that, once forward filtered, best match the input signals, are then used to reconstruct the desired output, with no ghost operator being applied. Also in this case, hence, no inversion is required. In GMP-JID, there is an important conceptual step as compared to the MIMAP application, because only filtered and aliased versions of the desired output are available (e.g. all the interpolator inputs are affected by ghosts), while in the technique disclosed in the MIMAP application, H₁(k_{y})≡1; and therefore, the forward model is applied only to particle velocities, and not explicitly to the pressure measurement, which is the one to be interpolated and de-aliased.

A general extension of the potential application of generalized matching pursuit as a practical and robust solution for the seismic applications, which makes use of the GSE theorem is described herein. For the example below, the case of two-channel joint interpolation and deconvolution is assumed. As can be appreciated by one of skill in the art, it is straightforward to extend the following results to a system that has more than two channels.

In the exemplary two channel system, there are two generic measurements, s₁(xₙ) and s₂(xₙ), that may be modeled as the sampled outputs of a bank of two filters H₁(k) and H₂(k), with input s(x), according to the scheme that is set forth in FIG. 2. It is assumed that the signal s(x) is spatially band-limited in a bandwidth up to the nominal sampling rate of the known measurements. Therefore, s₁(xₙ) and s₂(xₙ) are subject to spatial aliasing. It is also assumed that the forward model transfer functions H₁(k) and H₂(k) are known, that generate the two measurements, still according to the scheme that is set forth in FIG. 2. The ideal spectra of two measurements may be modeled, before decimation, in the wavenumber domain as follows:

S₁(k)=H₁(k)S(k)=S(k)(Re(H₁(k))+iIm(H₁(k))), and Eq. 8

S₂(k)=H₂(kₓ)S(k)=S(k)(Re(H₂(k))+iIm(H₂(k))), Eq. 9

where “Re(X)” and “Im(X)” represent the real and imaginary parts, respectively, of the argument X.

The (unknown) signal s(x) may be modeled at the sampled positions, xₙ, as a linear combination of a set of complex exponentials, used as basis functions, in the following way:

$$s ( {x}_{n} ) = {\sum }_{p} {A}_{p} exp ( j ( {k}_{p} {x}_{n} + {ψ}_{p} ) ) . \qquad Eq . 10$$

In Eq. 10, the p-th basis function is defined by three parameters: └Aₚ, ψₚ, kₚ┘, describing respectively the amplitude, the phase and the wavenumber of the complex exponentials.

Despite the fact that in this example complex exponentials are used as basis functions, other types of basis functions (e.g., cosines, damped exponentials, chirplets, wavelets, curvelets, seislets, etc.) may be used, in accordance with other embodiments of the invention.

The two measured signals may be described using the same set of basis functions, by applying the linear filters H₁(k) and H₂(k) of the forward model to them, as set forth below:

$$\begin{matrix}{s}_{1} ( {x}_{n} ) = {\sum }_{p} {A}_{p} exp ( j ( {k}_{p} {x}_{n} + {ψ}_{p} ) ) {H}_{1} ( {k}_{p} ) , \\ and & Eq . 11 \\ {s}_{2} ( {x}_{n} ) = {\sum }_{p} {A}_{p} exp ( j ( {k}_{p} {x}_{n} + {ψ}_{p} ) ) {H}_{2} ( {k}_{p} ) . & Eq . 12\end{matrix}$$

It is noted that in Eqs. 11 and 12, the unknowns are the same as in Eq. 10, and the forward filters are not subject to aliasing when the filters are applied to the basis functions.

With the generalized matching pursuit approach, iteratively, the basis functions that best match the inputs s₁(xₙ) and s₂(xₙ) are used to describe the desired output, s(x), at any desired position. At the j-th iteration, the best parameters set └Aⱼ, ψⱼ, kⱼ┘ is selected by minimizing the residual with respect to the two measurements, optionally weighted.

If “res[s₁(xₙ)]ⱼ₋₁” and “res[s₂(xₙ)]ⱼ₋₁” are the residuals at iteration j−1, then the following relationships apply:

$$\begin{matrix}{res [ {s}_{1} ( {x}_{n} ) ]}_{j - 1} = {s}_{1} ( {x}_{n} ) - {{\sum }^{j - 1}}_{p = 1} {A}_{p} exp ( i ( {k}_{p} {x}_{n} + {ψ}_{p} ) ) {H}_{1} ( {k}_{p} ) , \\ and & Eq . 13 \\ {res [ {s}_{2} ( {x}_{n} ) ]}_{j - 1} = {s}_{2} ( {x}_{n} ) = {{\sum }^{j - 1}}_{p = 1} {A}_{p} exp ( i ( {k}_{p} {x}_{n} + {ψ}_{p} ) ) {H}_{2} ( {k}_{p} ) , & Eq . 14\end{matrix}$$

With a least-squares approach, the best matching parameters set, at iteration j, is the set for which the parameters of the set minimize the energy of a cost function, as described below:

$$⌊ {A}_{j} , {ψ}_{j} , {k}_{j} ⌋ = {argmin}_{[ A , ψ , k ]} [ \begin{matrix}{\sum }_{n} {\vert {res [ {s}_{1} ( {x}_{n} ) ]}_{j - 1} - A exp ( i ( {kx}_{n} + ψ ) ) {H}_{1} ( k ) \vert}^{2} + \\ {\vert {res [ {s}_{2} ( {x}_{n} ) ]}_{j - 1} - A exp ( i ( {kx}_{n} + ψ ) ) {H}_{2} ( k ) \vert}^{2}\end{matrix} ] . \qquad Eq . 15$$

Some parametric weights may be used in Eq. 15 to balance the different signal-to-noise ratios (SNRs) in the two input measurements.

In the generalized matching pursuit technique, at the j-th iteration, Eq. 15 is solved, and the resulting parameters identify the j-th basis function to reconstruct the output. Note that the residuals in Eqs. 13 and 14 may be minimized with alternative approaches to the least-squares approach (e.g., approaches that use a L1 norm, or other approach).

Considering the example with complex exponential basis functions and a least squares cost function, the j-th basis functions may be described as follows:

$$\begin{matrix}{A}_{j} exp ( i ( 2 π {k}_{j} x + {φ}_{j} ) ) = {a}_{j} exp ( i 2 π {k}_{j} x ) - i {b}_{j} exp ( i 2 π {k}_{j} x ) , & Eq . 16 \\ {A}_{j} = \sqrt{{a}_{j}^{2} + {b}_{j}^{2}} , \\ and & Eq . 17 \\ {φ}_{j} = - atg ( \frac{{b}_{j}}{{a}_{j}} ) , & Eq . 18\end{matrix}$$

where “Aⱼ=\sqrt{aⱼ²+bⱼ²}” and “

$${φ}_{j} = - atg ( \frac{{b}_{j}}{{a}_{j}} )$$

allows the minimization problem in Eq. 15 to become linear with respect to aⱼ and bⱼ, and therefore, allow the analytical calculation of the best matching complex exponential for each wavenumber kⱼ. The aⱼ and bⱼ coefficients may be determined as follows:

$$\begin{matrix}{a}_{j} ( {k}_{j} ) == \frac{1}{N ( \begin{matrix}{\vert {H}_{1} ( {k}_{j} ) \vert}^{2} + \\ {\vert {H}_{2} ( {k}_{j} ) \vert}^{2}\end{matrix} )} [ {\sum }_{n} cos ( {k}_{j} , {x}_{n} ) [ \begin{matrix}Re ( {H}_{1} ( {k}_{j} ) ) Re ( {res [ {s}_{1} ( {x}_{n} ) ]}_{j - 1} ) + \\ Re ( {H}_{2} ( {k}_{j} ) ) Re ( {res [ {s}_{2} ( {x}_{n} ) ]}_{j - 1} )\end{matrix} ] ++ {\sum }_{n} cos ( {k}_{j} {x}_{n} ) [ \begin{matrix}Im ( {H}_{1} ( {k}_{j} ) ) Im ( {res [ {s}_{1} ( {x}_{n} ) ]}_{j - 1} ) + \\ Im ( {H}_{2} ( {k}_{j} ) ) Im ( {res [ {s}_{2} ( {x}_{n} ) ]}_{j - 1} )\end{matrix} ] ++ {\sum }_{n} sin ( {k}_{j} {x}_{n} ) [ \begin{matrix}Re ( {H}_{1} ( {k}_{j} ) ) Im ( {res [ {s}_{1} ( {x}_{n} ) ]}_{j - 1} ) + \\ Re ( {H}_{2} ( {k}_{j} ) ) Im ( {res [ {s}_{2} ( {x}_{n} ) ]}_{j - 1} )\end{matrix} ] ++ {\sum }_{n} sin ( {k}_{j} {x}_{n} ) [ \begin{matrix}- Im ( {H}_{1} ( {k}_{j} ) ) Re ( {res [ {s}_{1} ( {x}_{n} ) ]}_{j - 1} ) - \\ Im ( {H}_{2} ( {k}_{j} ) ) Re ( {res [ {s}_{2} ( {x}_{n} ) ]}_{j - 1} )\end{matrix} ] ] , \\ and & Eq . 19 \\ {b}_{j} ( {k}_{j} ) == \frac{1}{N ( \begin{matrix}{\vert {H}_{1} ( {k}_{j} ) \vert}^{2} + \\ {\vert {H}_{2} ( {k}_{j} ) \vert}^{2}\end{matrix} )} [ {\sum }_{n} sin ( {k}_{j} {x}_{n} ) [ \begin{matrix}Re ( {H}_{1} ( {k}_{j} ) ) Re ( {res [ {s}_{1} ( {x}_{n} ) ]}_{j - 1} ) + \\ Re ( {H}_{2} ( {k}_{j} ) ) Re ( {res [ {s}_{2} ( {x}_{n} ) ]}_{j - 1} )\end{matrix} ] ++ {\sum }_{n} sin ( {k}_{j} {x}_{n} ) [ \begin{matrix}Im ( {H}_{1} ( {k}_{j} ) ) Im ( {res [ {s}_{1} ( {x}_{n} ) ]}_{j - 1} ) + \\ Im ( {H}_{2} ( {k}_{j} ) ) Im ( {res [ {s}_{2} ( {x}_{n} ) ]}_{j - 1} )\end{matrix} ] ++ {\sum }_{n} cos ( {k}_{j} {x}_{n} ) [ \begin{matrix}- Re ( {H}_{1} ( {k}_{j} ) ) Im ( {res [ {s}_{1} ( {x}_{n} ) ]}_{j - 1} ) - \\ Re ( {H}_{2} ( {k}_{j} ) ) Im ( {res [ {s}_{2} ( {x}_{n} ) ]}_{j - 1} )\end{matrix} ] ++ {\sum }_{n} cos ( {k}_{j} {x}_{n} ) [ \begin{matrix}Im ( {H}_{1} ( {k}_{j} ) ) Re ( {res [ {s}_{1} ( {x}_{n} ) ]}_{j - 1} ) + \\ Im ( {H}_{2} ( {k}_{j} ) ) Re ( {res [ {s}_{2} ( {x}_{n} ) ]}_{j - 1} )\end{matrix} ] ] , & Eq . 20\end{matrix}$$

where “N” represents the number of samples in the input, and the functions “Re(X)” and “Im(X)” represent the real and the imaginary parts, respectively, of the complex number X.

The values obtained in Eqs. 19 and 20 may be substituted into Eq. 16 and hence, into Eq. 15. Eq. 15 then contains only one unknown: the wavenumber kⱼ. Thus, the cost function in Eq. 15 may be minimized, depending only on the wavenumber kⱼ. Once the wavenumber generating the minimum residual is identified, the amplitude and the phase of the best matching functions are obtained through Eqs. 16, 19 and 20. The new residual in the input is computed as described in Eq. 13 and 15, also considering the j-th basis function. The algorithm proceeds iteratively until the residual converges to a value as small as desired.

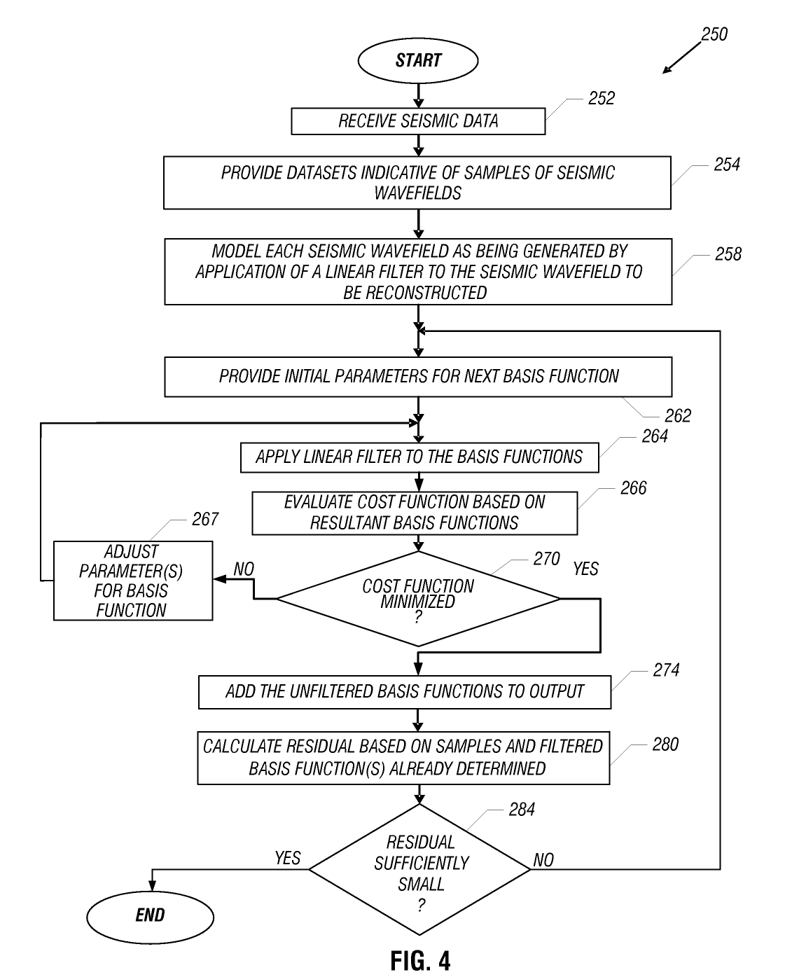

Referring to FIG. 4, to summarize, a technique 250 may be used to reconstruct an unaliased and continuous seismic wavefield in accordance with embodiments of the invention. Pursuant to the technique 250, seismic data are received (block 252) and from this seismic data, datasets are provided (block 254), which are indicative of samples of measurements of a seismic wavefield. Each seismic measurement is modeled as being generated by application of an independent linear filter to the seismic wavefield to be reconstructed, pursuant to block 258.

Next, the technique 250 begins an iterative process to determine the basis functions for the reconstructed wavefield. This iterative process first involves providing (block 262) initial parameters for the next basis function, applying (block 264) linear filters to the basis functions and based on the resultant basis functions, evaluating a cost function, pursuant to block 266. If a determination is made (diamond 270) that the cost function has not be minimized, then the parameters for the basis functions are adjusted, pursuant to block 267 and control returns to block 264.

Otherwise, if the cost function is minimized, then the unfiltered basis functions are added (block 274) to the output, and a residual is calculated (block 280) based on the samples and basis function(s) already determined, appropriately filtered by the modeled linear filters. If a determination is made, pursuant to diamond 284, that the residual is sufficiently small, then the technique 250 terminates. Otherwise, control returns to block 262 to provide the initial parameters for the next basis function.

As an example of a specific application, the interpolation of an upgoing marine seismic wavefield, in a bandwidth as wide as its original sampling rate is described below. The inputs for this two channel example, which are assumed to be known, are the samples of the upgoing wavefield and the samples of the upgoing wavefield's reflection. The upgoing and downgoing wavefields may be pressure or particle motion wavefields. If the upgoing and downgoing particle motion wavefields are considered, this application is complementary to the techniques described in U.S. patent application Ser. No. 12/169,260, entitled, “DEGHOSTING SEISMIC DATA,” which was filed on Jul. 8, 2008, where actual wavefield separation is obtained for the vertical component of velocities, in a multicomponent marine acquisition.

The application described below demonstrates how easily the generalized matching pursuit technique may be applied to the multichannel reconstruction of any seismic wavefield based on input signals that can be modeled as linearly filtered and decimated versions of the wavefield.

It is assumed that the up-going and the down-going wavefields separately are estimated or directly measured. These signals may be modeled as the decimated output of two filters having the same input. If the upgoing wavefield is considered to be the input, the two filters are the identity filter (for the up-going component), and a delay (for the down-going component) depending on frequency, wavenumber (kx, ky), propagation velocity (c) and streamer depth (Δz), as set forth below:

$$\begin{matrix}\begin{matrix}{f}^{UP} ( f , {k}_{x} , {k}_{y} ) = {H}_{1} ( f , {k}_{x} , {k}_{y} ) {f}^{UP} ( f , {k}_{x} , {k}_{y} ) \\ = {f}^{UP} ( f , {k}_{x} , {k}_{y} ) ,\end{matrix} \\ and & ( 21 ) \\ \begin{matrix}{f}^{DW} ( f , {k}_{x} , {k}_{y} ) = {H}_{2} ( f , {k}_{x} , {k}_{y} ) {f}^{UP} ( f , {k}_{x} , {k}_{y} ) = \\ = {f}^{UP} ( f , {k}_{x} , {k}_{y} ) \\ exp ( - i 2 Δ z \sqrt{{( \frac{2 π f}{c} )}^{2} - {( 2 π {k}_{x} )}^{2} - {( 2 π {k}_{y} )}^{2}} ) .\end{matrix} & ( 22 )\end{matrix}$$

Eq. 22 may be simplified using the following simplifying notation:

$$ψ ( f , {k}_{x} , {k}_{y} ) = - 2 Δ z \sqrt{{( \frac{2 π f}{c} )}^{2} - {( 2 π {k}_{x} )}^{2} - {( 2 π {k}_{y} )}^{2}} . \qquad Eq . 23$$

With this notation, Eq. 22 may be described as follows:

f^{DW}(f,kₓ,k_{y})=f^{UP}(f,kₓ,k_{y})exp(iψ(f,kₓ,k_{y},Δz)). Eq. 24

As can be seen, Eqs.21 and 22 comply with the GSE theorem.

If operating in the (f,kₓ,y) domain and the frequency f, and the inline wavenumber kₓ are assumed to be constant, then interpolation may be performed in the crossline (y) direction. For notational reasons, f and kₓ, which are constant, are omitted in the following description and “k_{y}” is indicated simply as “k.”

At the generic sample position, yₙ, the two measurements may be modeled as a combination of a set of basis functions (complex exponentials for this example) in the following way:

$$\begin{matrix}{f}^{UP} ( {y}_{n} ) = {\sum }_{j = 1}^{J} {A}_{j} exp ( i ( 2 π {k}_{j} {y}_{n} + {φ}_{j} ) ) , \\ and & Eq . 25 \\ {f}^{DW} ( {y}_{n} ) = {\sum }_{j = 1}^{J} {A}_{j} exp ( i ( 2 π {k}_{j} {y}_{n} + {φ}_{j} + ψ ( {k}_{j} ) ) ) , & Eq . 26\end{matrix}$$

Using the notation set forth above, the following relationships are obtained:

s₁(yₙ)=f^{UP}(yₙ), Eq. 27

s₂(yₙ)=f^{DW}(yₙ), Eq. 28

Re(H₁(k))=1, Eq. 29

Im(H₁(k))=0, Eq. 30

Re(H₂(k))=cos [ψ(k)], and Eq. 31

Im(H₂(k))=sin [ψ(k)]. Eq. 32

These relationships consequently result in the following:

|H₁(k)|²+|H₂(k)|²=2. Eq. 33

Substituting the terms of Eq. 16 and 17 in Eq. 11, the best matching parameters to be associated to each basis functions at the j-th iteration are as follows:

$$\begin{matrix}{a}_{j} ( {k}_{j} ) = \frac{1}{2 N} {\sum }_{n} cos ( {k}_{j} , {y}_{n} ) [ \begin{matrix}Re ( {res [ {f}^{UP} ( {y}_{n} ) ]}_{j - 1} ) + \\ Re ( {res [ {f}^{DW} ( {y}_{n} ) ]}_{j - 1} ) cos [ ψ ( {k}_{j} ) ] + \\ Im ( {res [ {f}^{DW} ( {y}_{n} ) ]}_{j - 1} ) sin [ ψ ( {k}_{j} ) ]\end{matrix} ] ++ \frac{1}{2 N} {\sum }_{n} sin ( {k}_{j} , {y}_{n} ) [ \begin{matrix}Im ( {res [ {f}^{UP} ( {y}_{n} ) ]}_{j - 1} ) + \\ Im ( {res [ {f}^{DW} ( {y}_{n} ) ]}_{j - 1} ) cos [ ψ ( {k}_{j} ) ] - \\ Re ( {res [ {f}^{DW} ( {y}_{n} ) ]}_{j - 1} ) sin [ ψ ( {k}_{j} ) ]\end{matrix} ] , \\ and & Eq . 34 \\ {b}_{j} ( {k}_{j} ) = \frac{1}{2 N} {\sum }_{m} sin ( {k}_{j} {y}_{n} ) [ \begin{matrix}Re ( {res [ {f}^{UP} ( {y}_{n} ) ]}_{j - 1} ) + \\ Re ( {res [ {f}^{DW} ( {y}_{n} ) ]}_{j - 1} ) cos [ ψ ( {k}_{j} ) ] + \\ Im ( {res [ {f}^{DW} ( {y}_{n} ) ]}_{j - 1} ) sin [ ψ ( {k}_{j} ) ]\end{matrix} ] ++ \frac{1}{2 N} {\sum }_{m} cos ( {k}_{j} {y}_{n} ) [ \begin{matrix}- Im ( {res [ {f}^{UP} ( {y}_{n} ) ]}_{j - 1} ) - \\ Im ( {res [ {f}^{DW} ( {y}_{n} ) ]}_{j - 1} ) cos [ ψ ( {k}_{j} ) ] + \\ Re ( {res [ {f}^{DW} ( {y}_{n} ) ]}_{j - 1} ) sin [ ψ ( {k}_{j} ) ]\end{matrix} ] , & Eq . 35\end{matrix}$$

Hence, with the optimal values computed according to Eqs.34 and 35, iterations may be performed, as described above.

This formulation allows the de-aliasing of aliased events up to any order of aliasing, provided certain conditions are met: this feature is an important property of the generalized matching pursuit technique, when used for multi-channel reconstruction.

It is noted that depending on the particular embodiment of the invention, the samples acquired in the measurements may be associated with a grid of uniformly-spaced sensor locations or may be associated with irregularly-spaced sensor locations. Additionally, the interpolated measurements may be associated with desired regularly or irregularly spaced locations.

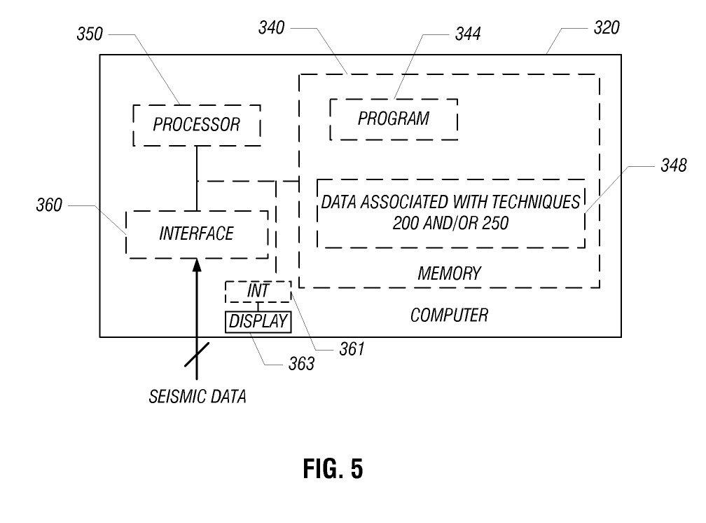

Referring to FIG. 5, in accordance with some embodiments of the invention, a data processing system 320 contains a processor 350 that processes acquired seismic data to perform at least some parts of one or more of the techniques that are disclosed herein for such purposes (as non-limiting examples) of constructing a substantially unaliased and continuous representation of a seismic wavefield; determining forward filters; determining basis functions; evaluating cost functions; determining residuals; modeling a GSE compliant system; relating samples to a wavefield to be reconstructed using linear filters; pre-processing acquired seismic data for purposes of deghosting; etc.

In accordance with some embodiments of the invention, the processor 350 may be formed from one or more microprocessors and/or microcontrollers. As non-limiting examples, the processor 350 may be located on a streamer 30 (see FIG. 1), located on the vessel 20 (see FIG. 1) or located at a land-based processing facility, depending on the particular embodiment of the invention.

The processor 350 may be coupled to a communication interface 360 for purposes of receiving such data as the acquired seismic data (data indicative of P, V_{z} and V_{y} measurements, as non-limiting examples). As examples, the communication interface 360 may be a Universal Serial Bus (USB) interface, a network interface, a removable media (such as a flash card, CD-ROM, etc.) interface or a magnetic storage interface (IDE or SCSI interfaces, as examples). Thus, the communication interface 360 may take on numerous forms, depending on the particular embodiment of the invention.

In accordance with some embodiments of the invention, the communication interface 360 may be coupled to a memory 340 of the system 320 and may store, for example, various input and/or output datasets involved in the determinations of the above-described reconstruction wavefields; basis functions; cost function evaluations; etc. The memory 340 may store program instructions 344, which when executed by the processor 350, may cause the processor 350 to perform various tasks of one or more of the techniques and systems that are disclosed herein, such as the techniques 200 and/or 250; and the system 320 may display preliminary, intermediate and/or final results obtained via the technique(s)/system(s) on a display 363 that is coupled to the system 320 by a display interface 361, in accordance with some embodiments of the invention.

Other variations are contemplated and are within the scope of the appended claims. For example, the techniques and system that are disclosed herein may be applied to construct an unaliased and continuous representation of a wavefield based on measurements acquired by sensors disposed in sensor cables other than streamers. As non-limiting examples, these other sensor cables may be seabed or land-based sensor cables.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method to reconstruct a seismic wavefield, comprising:
receiving datasets, each dataset being indicative of samples of one of a plurality of measurements of a seismic wavefield associated with a seismic survey;
modeling the plurality of measurements of a seismic wavefield as being generated by the application of at least one linear filter to the seismic wavefield; and
processing the datasets based on the linear filters and a generalized matching pursuit technique to generate data indicative of a spatially continuous representation of the seismic wavefield.

2. The method of claim 1, wherein the samples are associated with seismic sensor locations and the representation of the seismic wavefield spans locations other than the sensor locations.

3. The method of claim 1, wherein the samples are associated regularly or irregularly spaced sensor locations and desired locations associated with the spatially continuous representation are regularly or irregularly spaced locations.

4. The method of claim 1, wherein the measurements are affected by spatial aliasing due to sampling.

5. The method of claim 1, wherein the processing comprises:
representing the seismic wavefield as a linear combination of basis functions.

6. The method of claim 5, wherein the basis functions comprise at least one of the following:
complex functions, sinusoidal functions, damped exponential functions, chirplets, wavelets, curvelets and seislets.

7. The method of claim 6, wherein the processing further comprises:
performing iterations; and
for each iteration, determining one of the basis functions.

8. The method of claim 7, further comprising:
for each iteration, determining at least one parameter of said one of the basis functions which minimizes a cost function.

9. The method of claim 7, further comprising:
for each iteration, determining a wavenumber for said at least one of the basis functions which minimizes a cost function.

10. The method of claim 7, wherein the act of performing the iterations comprises, for each iteration:
determining a residual based on the samples of the measured wavefields, the basis functions that have been determined, and the filters; and
determining whether to proceed with another iteration based on the residual.

11. The method of claim 5, further comprising:
applying one or more linear filters that relate the samples to the spatially continuous wavefield to the basis functions to determine a cost function.

12. The method of claim 1, wherein the samples comprise samples acquired during the seismic survey.

13. The method of claim 1, wherein the samples comprise samples estimated based on samples acquired during the survey.

14. The method of claim 1, wherein the seismic wavefield comprises an upgoing seismic wavefield.

15. An apparatus, comprising:
an interface to receive datasets, each dataset being indicative of samples of one of a plurality of measurements of a seismic wavefield associated with a seismic survey; and
a processor to process the datasets based on at least one linear filter and a generalized matching pursuit technique to generate data indicative of a continuous representation of a seismic wavefield,
wherein each of the plurality of measurements of a seismic wavefield is modeled as being generated by the application of said at least one linear filter to the seismic wavefield.

16. The apparatus of claim 15, wherein the samples are associated regularly or irregularly spaced sensor locations and desired locations associated with the spatially continuous representation are regularly or irregularly spaced locations.

17. The apparatus of claim 15, wherein the measurements are affected by spatial aliasing due to sampling.

18. The apparatus of claim 15, wherein the processor is adapted to apply one or more linear filters that relate the samples to the spatially continuous wavefield to the basis functions to determine a cost function.

19. The apparatus of claim 15, wherein the datasets are derived from seismic data acquired in the seismic survey, the apparatus further comprising:
at least one seismic streamer to acquire seismic data from which the datasets are derived; and
a vessel to tow said at least one seismic streamer.

20. The apparatus of claim 15, wherein the seismic wavefield is represented as a linear combination of basis functions, and the processor is adapted to:
perform iterations; and
for each iteration, determine one of the basis functions.

21. The apparatus of claim 20, wherein the processor is adapted to:
for each iteration, determine at least one parameter of said of the basis functions which minimizes a cost function.

22. The apparatus of claim 20, wherein the processor is adapted to:
for each iteration, determine a wavenumber for said one of the basis function which minimizes a cost function.

23. The apparatus of claim 20, wherein the processor is adapted to:
for each iteration:
determine a residual based on the samples of the measured wavefields, the basis functions that have been determined, and the filters; and
determine whether to proceed with another iteration based on the residual.

24. An article comprising a computer readable storage medium containing instructions that when executed by a computer cause the computer to:
receive datasets, each dataset being indicative of samples of one of a plurality of measurements of a seismic wavefield associated with a seismic survey; and
process the datasets based on at least one linear filter and a generalized matching pursuit technique to generate data indicative of a representation of the first wavefield,
wherein each of the plurality of measurements of a seismic wavefield is modeled as being generated by the application of said at least one linear filter to the seismic wavefield.

25. The article of claim 24, wherein the seismic wavefield is represented as a linear combination of basis functions and the storage medium storing instructions that when executed cause the computer to:
perform iterations; and
for each iteration, determine one of the basis functions.

26. The article of claim 25, the storage medium storing instructions to cause the computer to:
for each iteration, determine at least one parameter of said one of the basis functions which minimizes a cost function.

27. The article of claim 24, the storage medium storing instructions to cause the computer to, for each iteration:
determine a residual based on the samples of the measured wavefields, the basis functions that have been determined, and the filter; and
determine whether to proceed with another iteration based on the residual
